(19) United States
(12) Patent Application Publication
(10) Pub. No.: US 2016/0101722 A1
(43) Pub. Date: Apr. 14, 2016

(54) LIGHT ACTUATION SYSTEM FOR MACHINES

(71) Applicant: Caterpillar Paving Products Inc., Brooklyn Park, MN (US)

(72) Inventors: Andrew R. Kopca, Andover, MN (US); Daniel H. Killion, Cary, NC (US); Jason B. Larson, Zimmerman, MN (US)

(73) Assignee: Caterpillar Paving Products Inc., Brooklyn Park, MN (US)

(21) Appl. No.: 14/972,111

(22) Filed: Dec. 17, 2015

(51) Int. Cl. B60Q 1/24; B60Q 1/00; B60Q 3/02; E01C 23/12; B60Q 1/26

(52) U.S. Cl. CPC B60Q 1/24; E01C 23/12; B60Q 1/2661; B60Q 3/0279; B60Q 3/0293; B60Q 1/0076; E01C 2301/30; E01C 2301/40

(57) ABSTRACT

A cold planer is disclosed herein. The cold planer includes a frame, a platform, an operator station, a ladder, a platform and stair illumination device, an operator-station illumination device, a forward keypad, a rearward keypad, a timer, and a controller. The platform and stair illumination device illuminates the platform and the ladder. The operator-station illumination device illuminates the operator station. The forward keypad includes first control buttons, which generates a first signal, upon actuation. The rearward keypad includes second control buttons, which generates a second signal, upon actuation. The controller is adapted to receive the first signal and second signal, correspondingly activate the platform and stair illumination device and the operator-station illumination device, set the timer to a predetermined period of time and deactivate the stair illumination device and the operator station illumination device when the predetermined period of time elapses.

### TECHNICAL FIELD

The present disclosure relates generally to cold planers. More specifically, the present disclosure relates to a light actuation system for a cold planer that facilitates actuation of a platform and stair illumination device and an operator-station illumination device.

### BACKGROUND

Cold planers are commonly known, in heavy machine industry, to perform milling operations on a work surface, such as but not limited to, a paved area laid over a road, a bridge, and a parking lot. A cold planer generally employs an operator station, a platform, a ladder, an operator-station illumination device, and a platform and stair illumination device. During low illumination operating conditions, the operator-station illumination device and the platform and stair illumination device are respectively actuated, to illuminate the operator station, the platform, and the ladder of the cold planer. In general, the cold planer employs a light actuation system to actuate the operator-station illumination device and the platform and stair illumination device of the cold planer.

Conventional light actuation systems include a key switch installed on the operator cabin, distal from the ground surface. When triggered, the key switch facilitates actuation of the platform and stair illumination device and the operator-station stair illumination device. In general, the operator is required to climb the ladder, to access and trigger the key switch of the light actuation system. It may be cumbersome for the operator to climb the ladder in such low illuminated operating conditions. Moreover, the key switch may be left triggered, after completion of the milling operation and the operator has climbed or descended from the ladder. This may cause unnecessary operation of the platform and stair illumination device and the operator-station stair illumination device and may result in significant energy wastage.

Japanese Patent No. 2,000,177,479 discloses a remote controller to remotely switch on and off lights of a hydraulic shovel. Although, the remote controller facilitates an operator to actuate the lights without climbing the ladder of the hydraulic shovel, the remote controller requires an additional cost and may be lost during operation of the hydraulic shovel.

### SUMMARY OF THE INVENTION

One aspect of the present disclosure is directed towards a cold planer. The cold planer includes a frame, a platform, an operator station, a ladder, a platform and stair illumination device, an operator-station illumination device, a forward keypad, a rearward keypad, a timer, and a controller. The platform is structured and arranged on the frame. The operator station is structured and arranged on the frame. The ladder includes a first end and a second end. The first end is coupled to a base portion of the frame. The second end is coupled to a cab access portion of the frame. The platform and stair illumination device is adapted to illuminate the platform and the ladder. The operator-station illumination device is adapted to illuminate the operator station. The forward keypad includes a plurality of first control buttons and is installed forward relative to the ladder. Each of the first control buttons are adapted to generate a first signal, when actuated. The rearward keypad includes a plurality of second control buttons and is installed rearward relative to the ladder. Each of the second control buttons are adapted to generate a second signal, when actuated. The controller is operatively connected to each of the forward keypad, the rearward keypad, and the timer. The controller is adapted to receive the first signal and the second signal, respectively from any of the first control buttons and any of the second control buttons. In addition, the controller is adapted to activate the platform and stair illumination device and the operator-station illumination device, upon a receipt of either of the first signal and the second signal. Further, the controller sets the timer to a predetermined period of time and deactivate the platform and stair illumination device and the operator-station illumination device when the predetermined period of time elapses.

Another aspect of the present disclosure is directed towards a cold planer. The cold planer includes a frame, a platform, an operator station, a ladder, a platform and stair illumination device, an operator-station illumination device, at least one keypad, a timer, and a controller. The platform is structured and arranged on the frame. The operator station is structured and arranged on the frame. The ladder includes a first end and a second end. The first end is coupled to a base portion of the frame. The second end is coupled to a cab access portion of the frame. The platform and stair illumination device is adapted to illuminate the platform and the ladder. The operator-station illumination device is adapted to illuminate the operator station. The at least one keypad is installed on the base portion of the frame and includes a plurality of control buttons. Each of the control buttons are adapted to generate a signal, when actuated. The controller is operatively connected to each of the forward keypad, the rearward keypad, and the timer. The controller is adapted to receive the signal from any of the control buttons. In addition, the controller is adapted to activate the platform and stair illumination device and the operator-station illumination device, upon a receipt of the signal. Further, the controller sets the timer to a predetermined period of time and deactivate the platform and stair illumination device and the operator-station illumination device when the predetermined period of time elapses.

### BRIEF DESCRIPTION OF THE DRAWINGS

FIG. 1 is a perspective view of a cold planer that illustrates an operator-station illumination device and a platform and stair illumination device, in accordance with the concepts of the present disclosure;

FIG. 2 is a block diagram of a light actuation system that facilitates actuation of the operator-station illumination device and the platform and stair illumination device of FIG. 1, in accordance with the concepts of the present disclosure; and

FIG. 3 is a flow chart of a method followed by the light actuation system to actuate the operator-station illumination device and the platform and stair illumination device of FIG. 1, in accordance with the concepts of the present disclosure.

### DETAILED DESCRIPTION

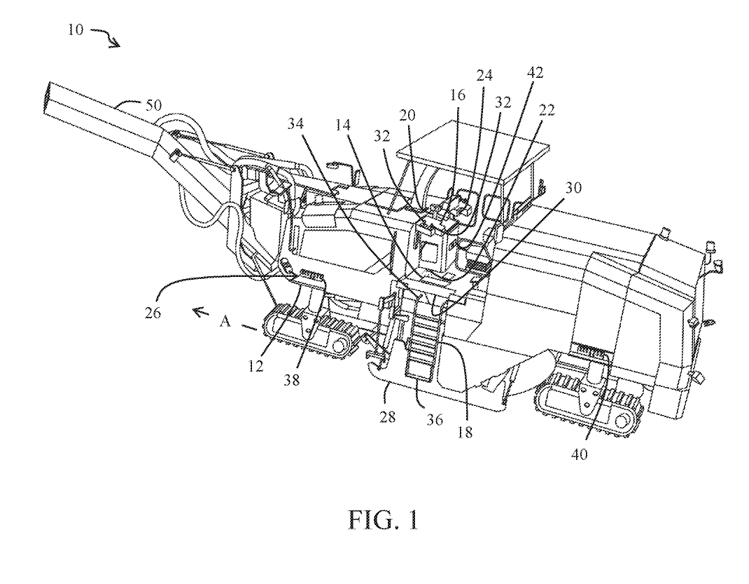

Referring to FIG. 1, there is shown a machine, which may be a cold planer 10. The cold planer 10 is adapted to perform milling operations on a work surface, such as but not limited to, paved area laid over a road, a bridge, or a parking area. The cold planer 10 includes a frame 12, a platform 14, an operator station 16, a ladder 18, an operator-station illumination device 20, a platform and stair illumination device 22, a key switch 24, and a light actuation system 26. Although, concepts of the present disclosure are described as applied to the cold planer 10, applicability to various other machines may also be contemplated. For example, concepts of the present disclosure may be applied to machines, such as but not limited to, a mining shovel, an excavator, a paving machine, and a reclaiming machine.

The frame 12 is a support structure that supports various other components of the cold planer 10. More specifically, the frame 12 refers to a machine body that supports the operator station 16, the ladder 18, the operator-station illumination device 20, and the platform and stair illumination device 22. The frame 12 defines a base portion 28 and a cab access portion 30, along a side section of the frame 12. The base portion 28 is defined proximal to a ground surface (not shown) and the cab access portion 30 is defined distal from the ground surface (not shown).

The platform 14 is structured and arranged on the frame 12, proximal to the cab access portion 30 of the frame 12. The platform 14 provides a base support for an operator to stand on the platform 14 and access the operator station 16, to facilitate functional items associated with the cold planer 10.

The operator station 16 is structured and arranged on the frame 12 above the platform 14 of the cold planer 10. The operator station 16 includes a number of control systems 32 that controls one or more functional items associated with the cold planer 10. In an embodiment, an operator may stand on the platform 14 and access the control systems 32 of the operator station 16, to operate the cold planer 10.

The ladder 18 is attached to the frame 12 of the cold planer 10. The ladder 18 includes a first end 34 and a second end 36. The first end 34 is coupled to the base portion 28 of the frame 12 and the second end 36 is coupled to the cab access portion 30 of the frame 12. Moreover, the ladder 18 is adapted to facilitate an operator to climb from the ground surface to the operator station 16, to access the control systems 32 of the operator station 16.

The operator-station illumination device 20 is a light emitting device installed within the operator station 16 of the cold planer 10. The operator-station illumination device 20 is adapted to illuminate the operator station 16 of the cold planer 10, upon actuation. Examples of the operator-station illumination device 20 may include, but is not limited to, an incandescent lamp, a gas discharge lamp, and an LED lamp.

The platform and stair illumination device 22 is a light emitting device installed proximal to the cab access portion 30 of the frame 12. The platform and stair illumination device 22 is adapted to illuminate the platform 14 and the ladder 18 of the cold planer 10, upon actuation. Examples of the platform and stair illumination device 22 may include, but is not limited to, an incandescent lamp, a gas discharge lamp, and an LED lamp.

The key switch 24 is an actuation switch of the cold planer 10. The key switch 24 is adapted to operate in an ON position and an OFF position. In the ON position, the key switch 24 actuates an ignition of the cold planer 10 and correspondingly actuates several associated electronic components of the cold planer 10. In the OFF position of the key switch 19, the cold planer 10 is inoperative and those electronic components of the cold planer 10 are inactive.

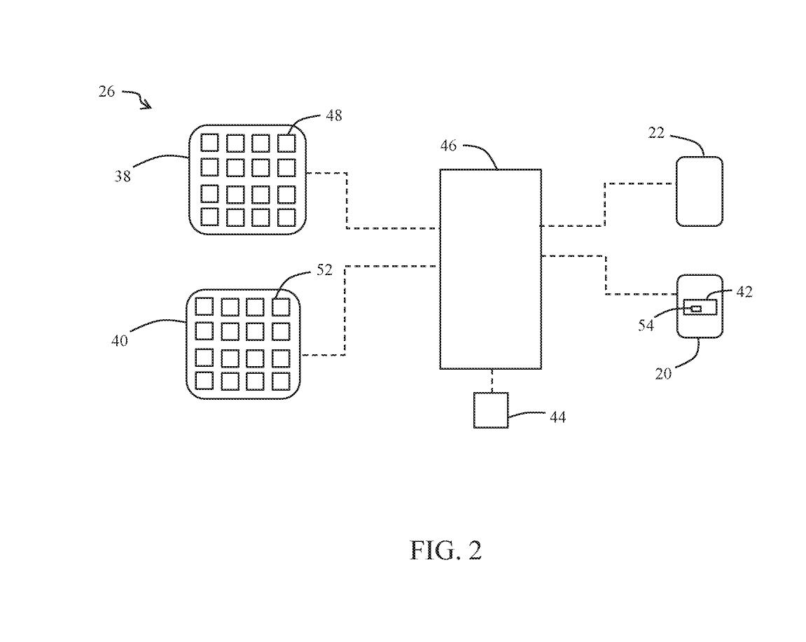

Referring to FIGS. 1 and 2, the light actuation system 26 of the cold planer 10, is shown. The light actuation system 26 is adapted to actuate the operator-station illumination device 20 and the platform and stair illumination device 22 of the cold planer 10, in the OFF position of the key switch 24. The light actuation system 26 includes a forward keypad 38, a rearward keypad 40, an operator-station keypad 42, a timer 44 (FIG. 2), and a controller 46 (FIG. 2). The forward keypad 38, the rearward keypad 40, the operator-station keypad 42, and the timer 44 are electrically connected to the controller 46 of the light actuation system 26.

The forward keypad 38 is a control panel installed on the base portion 28 of the frame 12. The forward keypad 38 is installed forward relative to the ladder 18, in a direction of travel, ‘A’ of the cold planer 10. The forward keypad 38 includes a number of first control buttons 48 (FIG. 2). Each of the first control buttons 48 (FIG. 2) are adapted to control one or more functionalities of the cold planer 10, when triggered in the ON position of the key switch 24. For example, one of the first control buttons 48 (FIG. 2) facilitates raising of a conveyor 50 of the cold planer 10, when triggered in the ON position of the key switch 24. Additionally, each of the first control buttons 48 are adapted to generate a first signal, when triggered in the OFF position of the key switch 24. Various types of the first control buttons 48 (FIG. 2) may be contemplated, such as but not limited to, push button, an ON-OFF switch, and a pedal switch.

The rearward keypad 40 is a control panel installed on the base portion 28 of the frame 12. The rearward keypad 40 is installed rearward relative to the ladder 18, in the direction of travel, ‘A’, of the cold planer 10. The rearward keypad 40 includes a number of second control buttons 52 (FIG. 2). Each of the second control buttons 52 (FIG. 2) are adapted to control one or more functional items associated with the cold planer 10, when triggered in the ON position of the key switch 24. For example, one of the second control buttons 52 (FIG. 2) facilitates lowering of the conveyor 50 of the cold planer 10, when triggered in the ON position of the key switch 24. Additionally, each of the second control buttons 52 (FIG. 2) are adapted to generate a second signal, when triggered in the OFF position of the key switch 24. Various types of the second control button 52 (FIG. 2) may be contemplated, such as but not limited to, push active button, an ON-OFF switch, and a pedal switch.

The operator-station keypad 42 is installed on the operator-station illumination device 20 of the cold planer 10. The operator-station keypad 42 includes a third control button 54 (FIG. 2). The third control button 54 (FIG. 2) is adapted to generate a third signal, when triggered in the OFF position of the key switch 24. Various types of the third control buttons 54 (FIG. 2) may be contemplated, such as but not limited to, push active button, an ON-OFF switch, and a pedal switch.

Referring of FIG. 2, the timer 44 of the light actuation system 26 is a clock based incremental timer that comprises of suitable logic, circuitry, interfaces, and/or code, which is actuated by the controller 46 for a predetermined period of time. The timer 44 is adapted to generate a termination signal, corresponding to completion of the predetermined period of time. Various types of the timer 44 may be contemplated, such as but not limited to, an analog timer, a digital timer, a counter based incremental timer, a clock based incremental timer, and a counter based detrimental timer.

The controller 46 comprises of suitable logic, circuitry, interfaces, and code that facilitates controlled actuation of the operator-station illumination device 20 and the platform and stair illumination device 22, based on an input from the first control buttons 48, the second control buttons 52, the third control button 54, and the timer 44. For this purpose, the controller 46 is electrically connected to each of the operator-station illumination device 20, the platform and stair illumination device 22, the first control buttons 48, the second control buttons 52, the third control button 54, and the timer 44. The controller 46 is adapted to receive the first signal, the second signal, and the third signal respectively from any of the first control buttons 48, any of the second control buttons 52, and the third control button 54. Additionally, the controller 46 is adapted to actuate the operator-station illumination device 20 and the platform and stair illumination device 22, corresponding to a receipt of either of the first signal, the second signal, and the third signal. Moreover, the controller 46 is adapted to actuate the timer 44 for the predetermined of time and then deactivate the operator-station illumination device 20 and the platform and stair illumination device 22, when the predetermined period of time elapses.

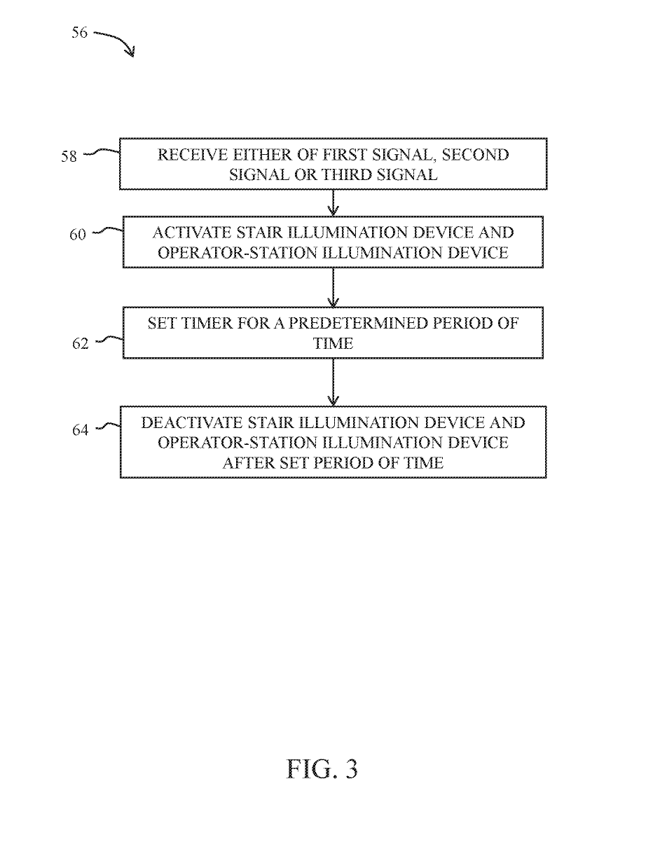

Referring to FIG. 3, there is shown a flowchart of a method 56 followed by the controller 46 to actuate the operator-station illumination device 20 and the platform and stair illumination device 22 of the cold planer 10. Notably, the method 56 is actuated, while the key switch 24 is in the OFF position. The method 56 initiates at step 58.

At step 58, the controller 46 receives either of the first signal, the second signal, and the third signal, respectively from any of the first control buttons 48, any of the second control buttons 52, and the third control button 54. In an embodiment, the controller 46 receives the first signal, the second signal, and the third signal, respectively, corresponding to trigger of any of the first control buttons 48, any of the second control buttons 52, and the third control button 54. The method 56 then proceeds to step 60.

At step 60, the controller 46 actuates the operator-station illumination device 20 and the platform and stair illumination device 22 of the cold planer 10. More specifically, the controller 46 actuates the operator-station illumination device 20 and the platform and stair illumination device 22, corresponding to receipt of either of the first signal, the second signal, or the third signal. The method 56 then proceeds to step 62.

At step 62, the controller 46 sets the timer 44 for a predetermined period of time. In an embodiment, the controller 46 inputs a timer value to the timer 44 and the timer 44 generates a termination signal as the predetermined time elapses. The method 56 then proceeds to step 64.

At step 64, the controller 46 deactivates the operator-station illumination device 20 and the platform and stair illumination device 22, corresponding to the receipt of the termination signal from the timer 44. More specifically, the controller 46 deactivates the operator-station illumination device 20 and the platform and stair illumination device 22, as the predetermined period of time elapses.

### INDUSTRIAL APPLICABILITY

Referring to FIG. 1, in operation, the cold planer 10 is initially inactive and the key switch 24 is in the OFF position. During low illumination operating conditions of the cold planer 10, an operator is required to actuate the operator-station illumination device 20 and the platform and stair illumination device 22 respectively, to illuminate the operator station 16, the platform 14, and the ladder 18 of the cold planer 10. More specifically, the operator may require actuating the operator-station illumination device 20 and the platform and stair illumination device 22, from the ground surface, while the key switch 24 is in the OFF position.

In order to facilitate such actuation, the operator triggers any of the first control buttons 48 of the forward keypad 38 or any of the second control buttons 52 of the rearward keypad 40. As the forward keypad 38 and the rearward keypad 40 are installed proximal to the ground surface, the operator can access and trigger the first control button 48 and the second control button 52 from the ground surface. This eliminates a need of climbing the ladder 18, to access and trigger the first control button 48 and the second control button 52 of the light actuation system 26. Although, the present disclosure discloses usage of either of the forward keypad 38 and the rearward keypad 40, usage of a singular keypad to actuate the operator-station illumination device 20 and the platform and stair illumination device 22, from the ground surface may also be contemplated. More specifically, usage of at least one keypad for actuation of the operator-station illumination device 20 and the platform and stair illumination device 22 is contemplated.

Referring to FIGS. 2 and 3, the first control button 48 and the second control button 52 respectively, generates the first signal and the second signal, when triggered. The controller 46 further follows the method 56 to actuate the operator-station illumination device 20 and the platform and stair illumination device 22. The controller 46 receives the first signal or the second signal, respectively from the first control button 48 and the second control button 52. Thereafter, the controller 46 actuates the operator-station illumination device 20 and the platform and stair illumination device 22, corresponding to receipt of the first signal or the second signal. The controller 46 then sets the timer 44 for a predetermined period of time. After the predetermined period of time elapses, the timer 44 generates a termination signal. The controller 46 receives the termination signal from the timer 44 and correspondingly deactivates the operator-station illumination device 20 and the platform and stair illumination device 22. Therefore, the operator-station illumination device 20 and the platform and stair illumination device 22 are automatically deactivated after a predetermined period of time. This avoids a need to deactivate the operator-station illumination device 20 and the platform and stair illumination device 22, after completion of the cold planer operation.

Furthermore, it may be noted that the first control buttons 48 and the second control buttons 52 control a number of functional items, in the ON position of the key switch 24. Therefore, the first control button 48 and the second control button 52 are used for dual purpose of controlling functionalities of the cold planer 10 in the ON position of the key switch 24, and actuating the operator-station illumination device 20 and the platform and stair illumination device 22 in the OFF position of the key switch 24. Therefore, the light actuation system 26 eliminates the need of an additional remote controller to control actuation of the operator-station illumination device 20 and the platform and stair illumination device 22. This avoids the additional cost incurred for the remote controller.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A cold planer, comprising:
a frame;
a platform structured and arranged on the frame;
an operator station structured and arranged on the frame;
a ladder including a first end and a second end, the first end being coupled to a base portion of the frame, the second end being coupled to a cab access portion of the frame;
a platform and stair illumination device adapted to illuminate the platform and the ladder;
an operator-station illumination device adapted to illuminate the operator station;
a forward keypad, relative to the ladder, including a plurality of first control buttons, wherein each of the plurality of first control buttons is adapted to generate a first signal when actuated;
a rearward keypad, relative to the ladder, including a plurality of second control button, wherein each of the plurality of second control buttons is adapted to generate a second signal when actuated;
a timer; and
a controller operatively connected to each of the forward keypad, the rearward keypad, and the timer, the controller being configured to:
receive the first signal from one or more of the plurality of first control buttons of the forward keypad;
receive the second signal from one or more of the plurality of second control buttons of the rearward keypad;
activate the platform and stair illumination device and the operator-station illumination device upon a receipt of either of the first signal and the second signal;
set the timer to a predetermined period of time; and
deactivate the platform and stair illumination device and the operator-station illumination device when the predetermined period of time elapses.

2. A cold planer comprising:
a frame;
a platform structured and arranged on the frame;
an operator station structured and arranged on the frame;
a ladder including a first end and a second end, the first end being coupled to a base portion of the frame, the second end being coupled to a cab access portion of the frame;
a platform and stair illumination device adapted to illuminate the platform and the ladder;
an operator-station illumination device adapted to illuminate the operator station;
at least one keypad installed on the base portion of the frame, the at least one keypad including a plurality of control buttons, wherein each of the plurality of control buttons is adapted to generate a signal when actuated;
a timer; and
a controller operatively connected to each of the at least one keypad and the timer, the controller being configured to:
receive the signal from one or more of the plurality of control buttons of the at least one keypad;
activate the platform and stair illumination device and the operator-station illumination device upon a receipt of the signal;
set the timer to a predetermined period of time; and
deactivate the platform and stair illumination device and the operator-station illumination device when the predetermined period of time elapses.
